(19) United States
(12) Patent Application Publication
(10) Pub. No.: US 2024/0429662 A1
(43) Pub. Date: Dec. 26, 2024

(54) Electric Connector Comprising a Pressure Sensitive Area and a Pressure Sensor

(71) Applicant: TE Connectivity Solutions GmbH, Schaffhausen (CH)

(72) Inventor: Gunter Feldmeier, Bensheim (DE)

(73) Assignee: TE Connectivity Solutions GmbH, Schaffhausen (CH)

(21) Appl. No.: 18/822,941

(22) Filed: Sep. 3, 2024

Related U.S. Application Data
(63) Continuation of application No. PCT/EP2023/055317, filed on Mar. 2, 2023.

(30) Foreign Application Priority Data
Mar. 4, 2022 (EP) 22160323.6

(51) Int. Cl. H01R 13/66; H01R 13/623; H01R 13/629

(52) U.S. Cl. CPC H01R 13/6683; H01R 13/623; H01R 13/629

(57) ABSTRACT

An electric connector includes at least one pressure sensitive surface and at least one pressure sensor. The pressure sensor is adapted to detect a pressure acting on the at least one pressure sensitive surface and to output a signal in response to the detection of pressure acting on the at least one pressure sensitive surface.

### CROSS-REFERENCE TO RELATED APPLICATION

This application claims the priority of International Patent Application No. PCT/EP2023/055317 filed on Mar. 2, 2023, which claims priority to EP patent application Ser. No. 22/160,323.6, filed on Mar. 4, 2022, the whole disclosures of which are incorporated herein by reference.

### FIELD OF THE DISCLOSURE

The present disclosure relates to an electric connector.

### BACKGROUND OF THE INVENTION

Electric connectors are commonly used for detachable connections of electric elements to allow, in a coupled state, the transmission of current and/or electric signals. For safety reasons, the correct position of the electric connector and connecting elements, such as a mating connector or a terminal, has to be ensured. In particular, unmating under load should be prevented. Such an unmating under load may lead to uncontrolled situations such as sparking, arcing or even burning. However, in various applications, the electric connectors are not protected from manipulation and accidents, which may cause loosening between connecting elements.

### SUMMARY OF THE INVENTION

According to an embodiment of the present disclosure, an electric connector includes at least one pressure sensitive surface and at least one pressure sensor. The pressure sensor is adapted to detect a pressure acting on the at least one pressure sensitive surface and to output a signal in response to the detection of pressure acting on the at least one pressure sensitive surface.

### BRIEF DESCRIPTION OF DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 is a perspective view of a connector crimped onto a circuit board according to an embodiment of the present disclosure;

FIG. 2 is an exploded view of the connector shown in FIG. 1;

FIG. 3 is a front view of the connector shown in FIG. 1;

FIG. 4 is a side view of the connector shown in FIG. 1;

FIG. 5 is a cross-sectional view of the connector taken along a line V-V shown in FIG. 1, showing a first fastener, a second fastener, and a shielding member assembled together;

FIG. 6 is a perspective view of the second fastener and the shielding member assembled together in FIG. 2;

FIG. 7 is a perspective view of the second fastener in FIG. 2 and the shielding member according to another embodiment of the present disclosure assembled together;

FIG. 8 is a perspective view of the individual shielding member in FIG. 7; and

FIG. 9 is a perspective view of a connector assembly according to an embodiment of the present disclosure.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Embodiments of the present disclosure include an electric connector comprising at least one pressure sensitive surface and at least one pressure sensor being configured to detect a pressure acting on the pressure sensitive surface and to output a signal in response to the detection of pressure on the at least one pressure sensitive surface.

The above-mentioned embodiment has the advantage that a signal representing the pressure acting on the pressure sensitive surface can be received. This signal can be representative of the current status of the electric connector. Thus, the signal can be used to determine whether the electric connector is being handled or manipulated. The above embodiment may be further improved by adding one or more of the following optional features. Each of the following optional features is advantageous on its own and may be combined independently with any other optional feature.

It is to be understood that the electric connector may be a data, a signal, a power or even a hybrid connector. In particular, the electric connector may be a connector without a breaking capacity. The above solution is especially advantageous for such electric connectors without a breaking capacity, as the consequence of manipulating such connectors under load may be quite severe. The consequences may range from losing the connector functionality to causing injuries or even killing the operator.

In one particularly advantageous embodiment, the electric connector may further comprise an alarm unit configured to receive a signal and be activated by the signal at a predetermined threshold value. The alarm unit may thus warn the operators that the electric connector is being manipulated. The operators can thus check the electric connector before any unintended disengagement or the like occurs. For example, the alarm unit may be configured to emit an optic and/or acoustic warning signal, which can be recognised by the operator. The threshold value may be a predetermined value which can be specifically determined for the corresponding application in order to reduce the chances of false alarms.

In one embodiment, the alarm unit may be activated when the pressure exceeds the threshold value. In another embodiment, the alarm unit may be activated when the pressure drops below the threshold value. In the former embodiment, it would be possible to register a force acting upon the pressure sensing surface, e.g. by someone gripping or pressing the electric connector. In the latter embodiment, it would be possible to register a decrease of pressure acting on the pressure sensitive surface, which may correspond to a decrease of a plugging force or the like. In one exemplary embodiment, the alarm unit may be automatically switched on when the threshold value is exceeded and subsequently activated when the pressure drops below the threshold value.

Preferably, the alarm unit may be integrated into a housing of the electric connector such that the status of the electric connector can be directly verified. Alternatively, the alarm unit may also be arranged remotely from the housing. The electric connector may comprise a cable for transmitting the signal from the pressure sensor to the alarm unit. The alarm unit may, for example, be a computer connected to the pressure sensor. In this case, the alarm unit may transmit and log a system notification and present it on a display.

In order to prevent any danger to the operator, the alarm unit may be configured to interrupt the supply of electric power through the connector when being activated. For example, the alarm unit may comprise a switch which opens by activation of the alarm unit. It is understood that any kind of interruption may be envisioned which leads to changes in the power supply through the electric connector. A system may be provided, having an emergency cutoff which can be controlled by the alarm unit. The alarm unit may be activated by a control unit and/or detection unit. Said control unit and/or detection unit can be arranged in a different component of the system, such as in an electric device.

Preferably, the alarm unit has a two-step alarm. A first alarm is activated at a first threshold value, indicating that pressure is applied on the pressure sensitive surface. A second alarm is activated at a second threshold value, indicating that the pressure sensitive surface is being moved. The first alarm may be a visual and/or optical alarm signal and the second alarm may be an emergency cutoff. The electric connector may comprise a power line for powering the alarm unit. Consequently, the alarm unit may be switched on only when the electric connector is powered. Alternatively, the alarm unit may be battery powered, which allows the alarm to be active even in a state in which the electric connector is not powered by a power line.

For maintenance purposes, it is particularly advantageous if an evaluation unit is provided. The evaluation unit is configured to count the number of times the alarm unit is activated. From this number it would, for example, be possible to evaluate the number of mating cycles between the electric connector and a mating connector. In particular, the number of times the alarm unit is activated may directly correspond to the number of mating cycles. In one exemplary embodiment, the electric connector may comprise at least one locking feature, the at least one locking feature being movable between a release position and a securing position for securing an element to the electric connector, wherein at least one pressure sensitive surface is located on the at least one locking feature. It is understood that an element may be a terminal which is mounted in a housing of the electric connector and secured within the housing by the at least one locking feature. Alternatively, the element may be a mating connector which is locked to the electric connector in a fully mated state. Furthermore, at least two locking features may be provided, one locking feature being configured to secure a terminal within the housing of the electric connector and the other locking feature being configured to secure the mating connector to the electric connector. Each locking feature may be provided with a pressure sensitive surface and a pressure sensor. Consequently, it can be easily determined which locking feature is being manipulated.

A manipulation of the at least one locking feature may be detected by the pressure sensor such that it is possible to determine whether the electric connector is being tampered with, such that an operator and/or the alarm unit may intervene.

The at least one locking feature may be a so-called terminal position assurance (TPA) or connector position assurance (CPA) feature. Once it is in the securing position, the correct position of the terminal or the connectors is ensured and does not change unless the position assurance is moved to the release position. However, applying pressure on the pressure sensitive surface to move the position assurance will be detected by the pressure sensor such that countermeasures may be applied in order to prevent any serious damage to the electric connector or the environment. The at least one locking feature may also be a secondary lock which secures a primary lock in the securing position.

Preferably, the at least one locking feature comprises an actuation surface which is adapted for manual interaction, wherein the pressure-sensitive surface is at least partially arranged on the actuation surface. For example, the at least one locking feature may be a locking lever having a handle. The actuation surface is formed on the handle, wherein pressing against the actuation surface causes a pivoting motion of the locking lever. In this case, the pivoting motion of the locking lever can be detected via the pressure sensor.

It is understood that the at least one locking feature may be any kind of locking feature. For example it may be a locking lever, a push-pull locking feature, a snapping hook locking feature, a screw locking feature, a bayonet locking feature or a sliding locking feature.

When the at least one pressure sensitive surface is arranged on a locking feature a disengagement between the electric connector and the element may be detected indirectly namely by a movement of the locking feature into the release position. Alternatively or additionally, a direct detection may be implemented by having the at least one pressure sensitive surface being adapted to receive a pressure from the element.

For example, the at least one pressure sensitive surface may be arranged at an interface of the electric connector. When mated with a mating connector, the mating connector either directly or indirectly presses against the pressure sensitive surface and the pressure sensor picks up the pressure. Upon unmating, a decrease of pressure can be detected and once the pressure drops below a threshold value, the alarm unit may be activated.

In particular, the electric connector may comprise a mating face facing a mating connector in a mating direction, wherein the pressure sensitive surface forms a part of the mating face.

The at least one pressure sensor may at least partially either directly or indirectly rest on the pressure sensitive surface. In order to prevent a sudden drop of pressure acting on the pressure sensitive surface, an elastically compressible intermediate element may be provided. The elastically compressible intermediate element may particularly be compressible in a direction essentially perpendicular to the at least one pressure sensitive surface. The intermediate element may particularly be a buffer providing a protection against sudden forces on the at least one pressure sensitive surface and/or the at least one pressure sensor. Consequently, the pressure is only gradually decreased upon unmating.

In one embodiment, the intermediate element may at least partially rest on the at least one pressure sensor, in particularly a sensing surface of the at least one pressure sensor. Particularly, the at least one pressure sensor may be arranged between the at least one pressure sensitive surface and the intermediate element. The at least one pressure sensor may particularly be directly mounted on the at least one pressure sensitive area.

Alternatively, the at least one pressure sensor may be at least partially or completely integrated in the intermediate element. The at least one pressure sensor may particularly be embedded in the intermediate element such that the intermediate element protects the at least one pressure sensor from damage.

The intermediate element may be adhesively fixed to the at least one pressure sensor. In particular, the at least one pressure sensor may be at least partially overmolded by the intermediate element.

In a particularly advantageous embodiment, the intermediate element may be a seal or at least part of a seal. In this embodiment, a compact sealed connection between the electric connector and mating connector can be provided. The at least one pressure sensor may at least partially be embedded in the seal. In particular for radial seals, the at least one pressure sensor may at least partially or even completely rest underneath the seal between the seal and the pressure sensing surface.

Advantageously, the electric connector may comprise a housing and an expansion module being replaceably mounted in the housing, wherein the at least one pressure sensor is arranged on the expansion module. A set may be provided, the set comprising at least two expansion modules, wherein one of the at least two expansion modules comprises the at least one pressure sensor and the other one of the at least two expansion modules does not comprise the at least one pressure sensor. The expansion module with the at least one pressure sensor may be of particular advantage as it may easily replace expansion modules without pressure sensors and thus can be used to retrofit electric connectors already in use.

The invention further concerns a connector arrangement comprising an electric connector according to any one of the above embodiments and a mating connector. The electric connector and the mating connector may be movable relative to one another between an unmated condition to a fully mated condition and wherein the mating connector and the electric connector are configured to exert a pressure on the pressure sensitive surface at least in the fully mated condition. Said pressure may be detected by the at least one pressure sensor, which sends a signal indicating that the connectors are in the fully mated condition. An unmating will be detected by the at least one pressure sensor, which allows to counteract the unmating and to prevent the connectors and/or the environment from being harmed.

Preferably, the electric connector may comprise a mating interface which faces a counter mating face of the mating connector. The at least one pressure sensor may be arranged on the mating interface while an elastically compressible intermediate element may be arranged on the counter mating face. When the intermediate element is pressed against the at least one pressure sensor, the intermediate element is compressed gradually increasing the pressure acting on the pressure sensor until reaching the fully mated condition. Unmating will lead to a gradual drop in pressure as the intermediate element relaxes instead of a sudden drop in pressure without an intermediate element.

The invention also relates to a system comprising an electric connector as described above and an electric device such as an automation device. The electric connector may be electrically coupled to the electric device and adapted to mate with a mating connector. The electric connector may, for example, be integrated in the electric device. For example, the electric connector may be mounted in a housing of the electric device. Alternatively, the electric device may be connected to the electric device via a cable or the like. The electric device may be a computer to which the electric connector is connected.

The system may comprise a detection unit configured to receive the signal from the at least one pressure sensor and activated by the signal at a predetermined threshold value. The detection unit may for example be integrated into the electric connector. However, in a preferred embodiment, the detection unit may be integrated into the electric device or even be a separate device coupled to the pressure sensor. Under an activation of the detection unit, it is understood that the detection unit may send out an output signal in response to the activation.

Furthermore, the system may comprise a control unit configured to receive an output signal from the detection unit. The control unit may be configured to automatically activate an alarm unit in response to being activated. In particular, the control unit may send out an activation signal to the alarm unit when activated. The alarm unit in turn may be configured to emit a warning signal, e.g. an acoustic and/or optical signal.

In one embodiment, at least two of the detection unit, the control unit and the alarm unit, or even all units, may be integrated into a common component of the system. Furthermore, at least two of the detection unit, the control unit and the alarm unit may be summarized in a single unit. Advantageously, at least the detection unit and the control unit may be coupled to the electric device and the alarm unit may be integrated in the electric connector.

The threshold value may be a predetermined value which can be specifically determined for the corresponding application in order to reduce the risk of false alarms. In one embodiment, the alarm unit may be activated when the pressure exceeds the threshold value. In another embodiment, the alarm unit may be activated when the pressure drops below the threshold value. In the former embodiment, it would be possible to register a force acting upon the pressure sensing surface, e.g. by someone gripping or pressing the electric connector. In the latter embodiment, it would be possible to register a decrease of pressure acting on the pressure sensitive surface, which may correspond to a decrease of a plugging force or the like. In one exemplary embodiment, the alarm unit may be automatically switched on when the threshold value is exceeded and subsequently activated when the pressure drops below the threshold value.

In order to prevent any danger to the operator, the control unit may be configured to interrupt the supply of electric power through the connector when being activated. For example, the control unit may flip a switch, activating the emergency cutoff. It is understood that any kind of interruption may be envisioned which leads to changes in the power supply through the electric connector. A system may be provided comprising an emergency cutoff which can be activated by the control unit.

Preferably, the system has a two-step alarm. A first alarm is activated at a first threshold value, indicating that pressure is applied on the pressure sensitive surface. A second alarm is activated at a second threshold value, indicating that the pressure sensitive surface is being moved. The first alarm may be a visual and/or optical alarm signal and the second alarm may be an emergency cutoff.

For maintenance purposes, it is particularly advantageous if an evaluation unit is provided. The evaluation unit is configured to count the number of times the detection unit is activated. From this number it would, for example, be possible to evaluate the number of mating cycles between the electric connector and a mating connector. In particular, the number of times the detection unit is activated may directly correspond to the number of mating cycles.

The detection unit may also directly emit a warning signal such that it functions both as a detection unit and an alarm unit. In one embodiment, the detection unit may send the output signal directly to an alarm unit. Preferably, the detection unit may be configured to send an output signal to activate the alarm unit at the first predetermined threshold value and to send an output signal to a control unit to execute an emergency cutoff at the second predetermined threshold value. In this case, the detection unit serves as a control unit for the alarm unit.

Furthermore, the system may comprise a mating connector configured to mate with the electric connector. In one embodiment, the alarm unit may be integrated in the mating connector.

In the following, exemplary embodiments are described with reference to the drawings. The embodiments shown and described are for explanatory purposes only. The combination of features shown in the embodiments may be changed according to the foregoing description. For example, a feature which is not shown in an embodiment but described above, may be added if the technical effect associated with this feature is beneficial to a particular application and vice versa (a feature shown as part of an embodiment may be omitted as described above, if the technical effect associated with this feature is not needed in a particular application). In the drawings, elements that correspond to each other with respect to function and/or structure have been provided with the same reference numeral.

In general, an electric connector 1 according to the present disclosure comprises at least one pressure sensitive surface 2 and at least one pressure sensor 4 being configured to detect a pressure acting on the pressure sensitive surface and to output a signal 3 in response to the detection of pressure on the at least one pressure sensitive surface 2.

The pressure sensitive surface 2 is a surface of the electric connector 1, on which a force is acted upon in specific situations, such as when mating and/or unmating the electric connector 1 from a mating connector 6. The at least one pressure sensor 4 may at least partially rest on the pressure sensitive surface 2, such that it is at least partially supported on the at least one pressure sensitive surface 2. The pressure sensitive surface 2 thus provides a counter bearing for the at least one pressure sensor 4.

The pressure sensor 4 may, for example, be a piezoelectric sensor. However, in a preferred embodiment, the pressure sensor 4 is not a piezoelectric sensor. The pressure sensor 4 may be a foil based pressure sensor. The foil based pressure sensor 4 may easily be applied on the pressure sensitive surface without greatly increasing the dimensions of the electric connector 1. Preferably, the at least one pressure sensor 4 may be flexible such that it may be bent allowing the pressure sensor 4 to be applied on a curved pressure sensitive surface.

The electric connector 1 may be part of a system 100. The system 100 may further comprise an electric device 102, such as an automation device or the like. The electric connector 1 may be electrically coupled to the electric device 102 and may be configured to mate with the mating connector 6.

The pressure sensor 4 may be connected to a detection unit 8, which is configured to receive the output signal 3 and be activated by the output signal 3 at a predetermined threshold value. Preferably, the pressure sensor 4 may comprise connection elements, such as wiring 10 for directly or indirectly connecting the pressure sensor 4 to the detection unit 8. The detection unit 8 may for example be integrated into a housing 12 of the electric connector 1. Alternatively or additionally, the detection unit 8 may be arranged remote from the housing of the electric connector. For example, the detection unit 8 may be a computer adapted to receive the output signal 3 from the at least one pressure sensor 4 or it may be integrated in an electric device 102.

Preferably, the detection unit 8 may be configured to be activated at a predetermined threshold value. By “being activated”, it is understood that the detection unit 8 outputs a signal 13. Said signal 13 may, for example, be output and saved into a cloud server, which can be accessed and checked for maintenance purposes. Preferably, a control unit 15 is provided, which receives the signal 13 of the detection unit 8 and in turn is configured to activate an alarm. The alarm may for example be a warning signal 5, which is emitted by an alarm unit 17. The alarm unit 17 may thus warn the operator that the electric connector 1 is being tampered with. In order to prevent any serious damage to the electric connector 1 and/or the surroundings, the control unit 15 may be configured to interrupt a power supply through the electric connector 1 after passing a predetermined threshold value. In one embodiment, the alarm unit 17 may be configured to be activated at a first predetermined threshold value and the control unit 15 may be configured to interrupt the power supply through the electric connector 1 at a second predetermined threshold value, the second predetermined threshold value being different to the first predetermined threshold value.

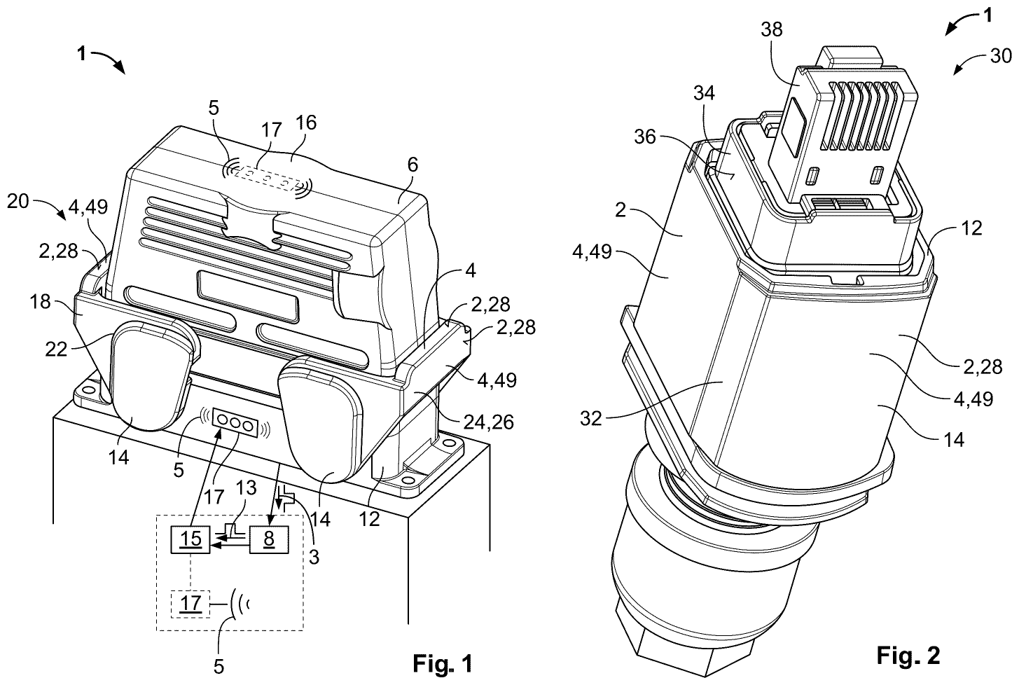

While the detection unit 8, the control unit 15 and the alarm unit 17 are referred to as individual units, it is understood that they may also be part of a single unit 19. The detection unit 8 and/or the control unit 15 may preferably be integrated in the electric device 102 or may form a separate device connected to the electric connector 1 and/or the electric device 102. The alarm unit 17 may be arranged on the electric connector 1, the mating connector 6 or the electric device 102. Thus, the alarm unit 17 may be positioned at the most convenient locations in each application, allowing good visibility and/or accessibility. In the following, the structure of possible embodiments of a first group of electric connectors 1 are explained with reference to FIGS. 1 to 5. The first group of electric connectors 1 have in common, that they are each provided with specific locking features 14 for securing an element 16 to the electric connector 1. Consequently, it is possible to detect any manipulation of the locking features 14, which thus indirectly indicates that the electric connector 1 is being unmated or the like. The element 16 may for example be a terminal being adapted to be mounted in the housing 12 or a mating connector 6 as illustrated in FIG. 1.

In FIG. 1, a connector assembly with a first exemplary embodiment of an electric connector 1 and a mating connector 6 is shown. The electric connector 1 comprises a housing 12 on which two locking levers 18 are mounted pivotably movable relative to the housing 12 from a release position to a securing position 20 as shown in FIG. 1. In the securing position 20, the locking levers 18 engage the mating connector 6, securing the mating connector 6 to the electric connector 1 and preventing unmating of these connectors.

The locking levers 18 are essentially U-shaped, having two lever arms 22 being attached to the housing 12 and a base 24 connecting the two lever arms 22. The base 24 is configured as a handle 26 having actuation surfaces 28 on which pressure is being applied in order to move the locking levers 18 back to the release position. The actuation surface 28 may thus be a pressure sensitive surface 2. The pressure sensor 4 may be a foil at least partially covering the actuation surface 28 such that any pressure acted upon the actuation surface will be registered by the pressure sensor 4.

An alarm unit 17 may be integrated in the electric connector 1, which for example may be adapted to emit an optical and/or acoustic warning signal. Preferably, the alarm unit 17 is activated upon applying pressure on the activation unit while being under load. For this, the signal 3 is received by the detection unit 8, which outputs the signal 13 to the control unit 15, which in turn activates the alarm unit 17. The activation may entail an optical and/or acoustic warning signal 5. Once the pressure is increased above a predetermined threshold value while being plugged and under load an emergency cutoff interrupting the power supply is executed by the control unit 15.

As is shown in FIG. 1, the alarm unit 17 may be integrated in the electric connector 1, in the mating connector 6 and/or in the electric device 102. Alternatively, the alarm unit 17 may be provided as a separate component, which is connected to at least one of the electric connector 1, the mating connector 6 and the electric device 102. Furthermore, FIG. 1 shows a single unit 19 which comprises the detection unit 8 and the control unit 15. Optionally, the alarm unit 17 may also be part of the single unit 19 as indicated with the dashed lines in FIG. 1.

In FIG. 2, a second exemplary embodiment of an electric connector 1 is shown. The electric connector 1 is a so called push-pull connector 30. It comprises a handling portion 32 for holding the electric connector 1. A support collar 34 having a smaller diameter than the handling portion 32 projects axially out of the handling portion 32. The support collar 34 provides support surfaces 36 for providing support for a radial seal, which can be mounted on the support collar 34. A connecting portion 38 having a smaller diameter than the support collar 34 projects axially beyond the support collar to a free end of the electric connector 1. The connecting portion 38 comprises electrically conductive elements in order to establish an electric connection with the mating connector 6.

When mated with a mating connector (not shown), the connecting portion and the collar are inserted into a socket of the mating connector. A wall of the mating connector may enter a radial gap between the handling portion 32 and the support collar 34. Within said gap locking features like latching hooks may be provided which latch onto the mating connector and block relative movement in the axial direction between the mating connector and the electric connector 1. In order to release the latching connection between the mating connector and the electric connector it is necessary to push against an actuation surface 28 of the handling portion. This will lead to an elastic deformation causing the locking features to disengage the mating connector.

Again, the pressure sensor 4 may be mounted on the actuation surface 28, e.g. the pressure sensor 4 may be adhesively fixed to the actuation surface 28 such that the pressure applied on the actuation surface 28 can be detected. As with the embodiment shown in FIG. 1, a detection unit, a control unit and an alarm unit (not shown) can be provided which in a first step emits an optic and/or acoustic signal and after a threshold value is exceeded performs an emergency cutoff.

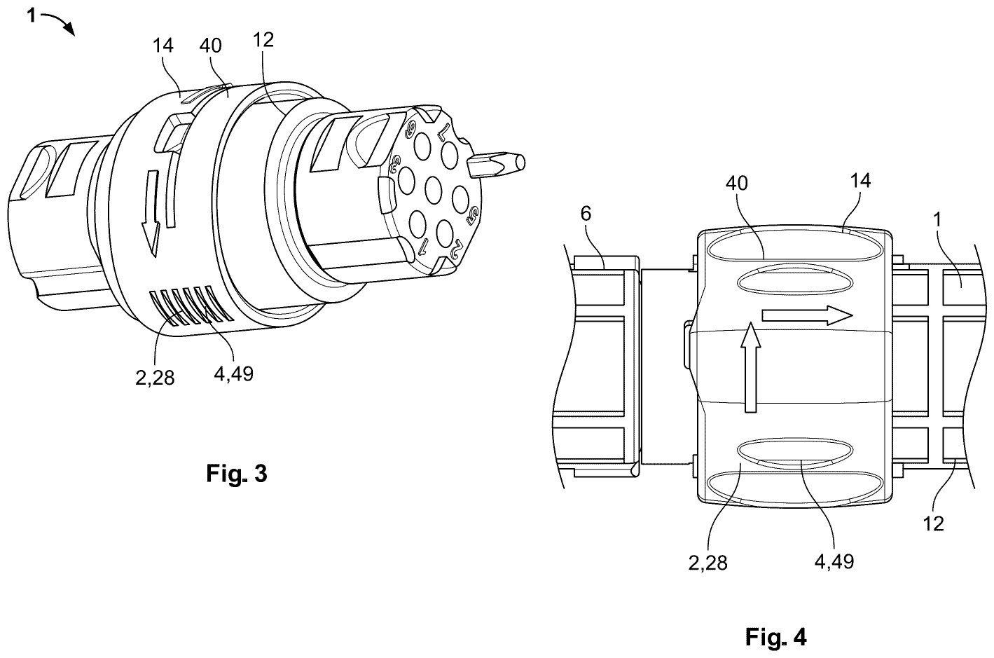

In FIGS. 3 to 5, circular embodiments of the electric connector 1 are shown. This circular connector comprises locking features in the form of locking sleeves 40. In the embodiment shown in FIG. 3, the locking sleeve 40 is has an essentially elliptical shape with diametrically arranged actuation surfaces 28. Upon pressing against the actuation surfaces, the locking sleeve 40 is elastically deformed. This deformation can cause a release of latching features such as snapping hooks or the like. In this exemplary embodiment, it is provided that at least one pressure sensor 4 is installed at least on the actuation surface 28.

The exemplary embodiment of FIG. 4 comprises a locking sleeve 40 for a bayonet locking arrangement. The locking sleeve 40 is provided with a radially inwards projecting protrusion, which is configured to enter into an undercut in a circumferential direction blocking a movement in the axial direction between the electric connector 1 and the mating connector 6.

To unlock the electric connector 1 from the mating connector 6, the locking sleeve 40 has to be twisted in a circumferential direction and then pulled in an axial direction away from the mating connector 6. Thus, a pressure is applied on the actuation surface 28 of the locking sleeve 40 when the locking sleeve 40 is gripped to move it in the circumferential and/or axial direction. This pressure can be measured by integrating the pressure sensor into the locking and/or actuation feature of the locking sleeve 40.

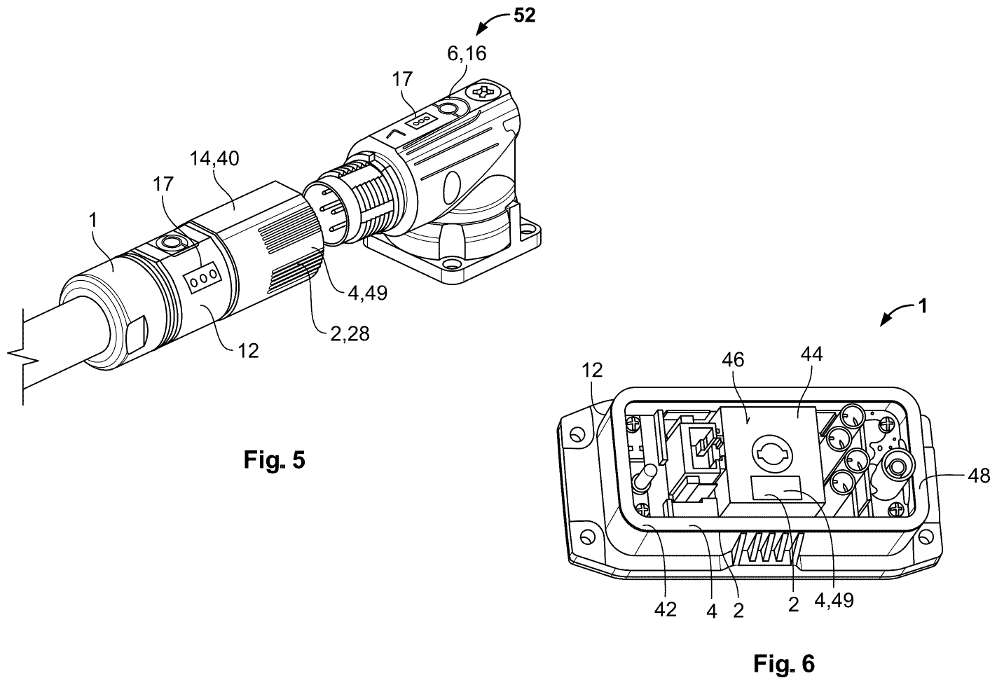

In FIG. 5, a circular connector having a locking sleeve 40 for screw lock applications is provided. The locking sleeve 40 may be rotated around its axis relative to the remainder of the electric connector 1 and may be provided with an internal thread. Again, a pressure sensor may be attached to the locking sleeve 40 such that a force acting upon the pressure sensitive surface of the locking sleeve 40 can be detected by the pressure sensor 4.

Each connector 1 may comprise an alarm unit 17 that activates upon applying pressure under load and optionally comprise a control unit 15 that executes an emergency cutoff when a threshold pressure value is exceeded under load.

Additionally or alternatively to providing pressure sensors on the locking features of the electric connector 1, the electric connector 1 may comprise a pressure sensitive surface 2 on which a force is applied by the mating connector 6 in a mated state. The pressure sensor 4 provided for detecting the pressure acting on such a pressure sensitive surface may thus transmit an output signal, which directly correlates to the mating status of the electric connector 1. Such an electric connector 1 is for example shown in FIG. 6.

The exemplary embodiment illustrated in FIG. 6 comprises a connector housing 12, an axial seal 42 installed on the connector housing 12 and multiple expansion modules 44 mounted in the housing 12. The expansion modules 44 may be replaceably mounted in the housing 12. Thus, a diverse spectrum of expansion modules 44 may be utilized depending on the application requirements. The expansion modules 44 form an interface for mating with the mating connector 6.

In this exemplary embodiment, at least one expansion module 44 may be provided, the at least one expansion module 44 comprising a pressure sensitive surface 2 and a pressure sensor 4 adapted to detect the pressure acting on the pressure sensitive surface 2. Thus, such an expansion module 44 may be easily retrofitted to electric connectors 1 already in use.

The pressure sensitive surface 2 may form part of a mating face 46 of the electric connector 1. The at least one pressure sensor 4 may be mounted on the mating face 46 such that it is clamped between the mating face 46 and the mating connector 6 in the fully mated condition.

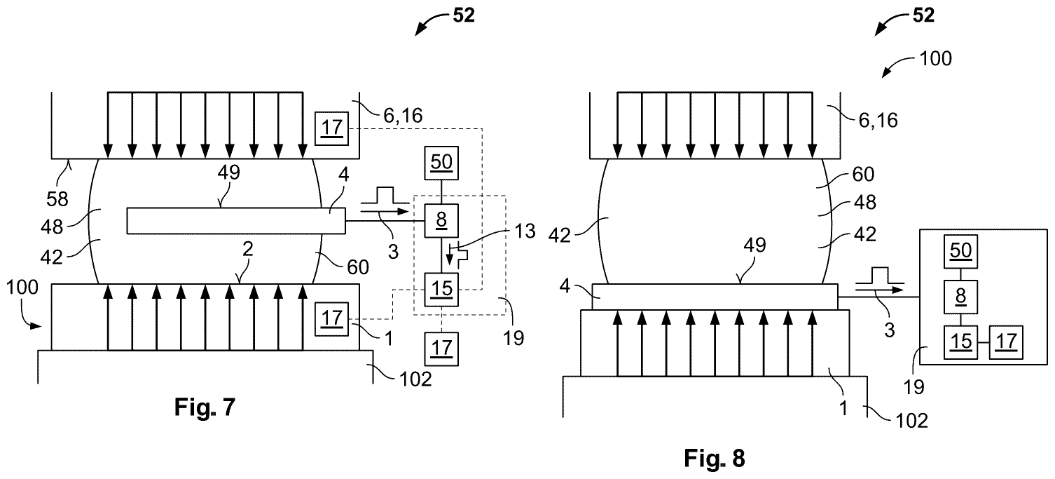

In order to prevent a sudden drop of pressure acting on the pressure sensitive surface, an elastically compressible intermediate element 48 as shown in FIGS. 7 and 8 can be provided. The elastically compressible intermediate element 48 may at least partially or completely rest on a sensing area 49 of the pressure sensor 4 as shown in FIG. 8. When a force is applied on the elastically compressible element 48, the elastically compressible intermediate element 48 is compressed in a direction perpendicular to the sensing area 49 and/or the pressure sensitive surface 2. Thus, the elastically compressible intermediate element 48 further acts as a buffer preventing damage to the pressure sensitive surface 2 and/or the sensing area 49 due to high force. Alternatively, the at least one pressure sensor 4 may at least partially be integrated in the elastically compressible intermediate element 48. For example, the at least one pressure sensor 4 may be at least partially or completely embedded in the intermediate element 48 as is shown in FIG. 7. Thus, the intermediate element 48 is arranged between the pressure sensor 4 and the pressure sensitive surface 2. The pressure sensor 4 may for example be overmolded by the intermediate element 48.

The intermediate element 48 may particularly be at least part of a seal 42. Thus, instead of providing the pressure sensor 4 on the mating face 46, it can be arranged at least partially underneath the axial seal 42. However, in order to not deteriorate the sealing performance, it is preferred that the pressure sensor 4 is at least partially or completely integrated into the seal 42. Completely integrated means that the entire sensing area 49 of the pressure sensor 4 is surrounded by the seal 42. The wiring 10 may project out of the seal 42 and lead to the detection unit 8.

For maintenance purposes, it is particularly advantageous if an evaluation unit 50 is provided. The evaluation unit 50 may be configured to count the number of times the detection unit 8 is activated. Thus, it is possible to evaluate the number of mating cycles of the electric connector 1. Preferably, the detection unit 8 and/or the evaluation unit 50 may be integrated in the electric device 102. However, it may also be possible to provide a system comprising a separate detection unit 8 and/or evaluation unit 50 and an electric connector 1 connected to the detection unit 8 and/or evaluation unit 50.

In the exemplary embodiment shown in FIG. 7, the signal 3 is transmitted to the detection unit 8 which outputs a signal 13 that is received by the control unit 15. The detection unit 8 and the control unit 15 are part of a single unit 19. Thus, from a macroscopic perspective, the detection and controlling function is performed directly by the single unit 19. The evaluation unit 50 may access the detection unit 8 in order to count the number of times the detection unit 8 has been activated. Furthermore, the control unit 15 may activate the alarm unit 17 which may either be arranged on the electric connector 1, the mating connector 6, the electric device 102 or be a separate component of the system 100.

In FIG. 8, a single unit 19 is shown, which comprises each unit, i.e. the evaluation unit 50, the detection unit 8, the control unit 15 and the alarm unit 17. Said single unit 19 may be integrated in the electric device 102 or provided as a separate component coupled to the pressure sensor.

The at least one pressure sensor 4 may also be integrated in a radial seal such as a seal for mounting on the support collar 34 in the embodiment of FIG. 2. In this embodiment, it would also be possible to arrange the at least one pressure sensor 4 completely underneath the radial seal, i.e. between the support surface 36 and the radial seal, without deteriorating the sealing performance.

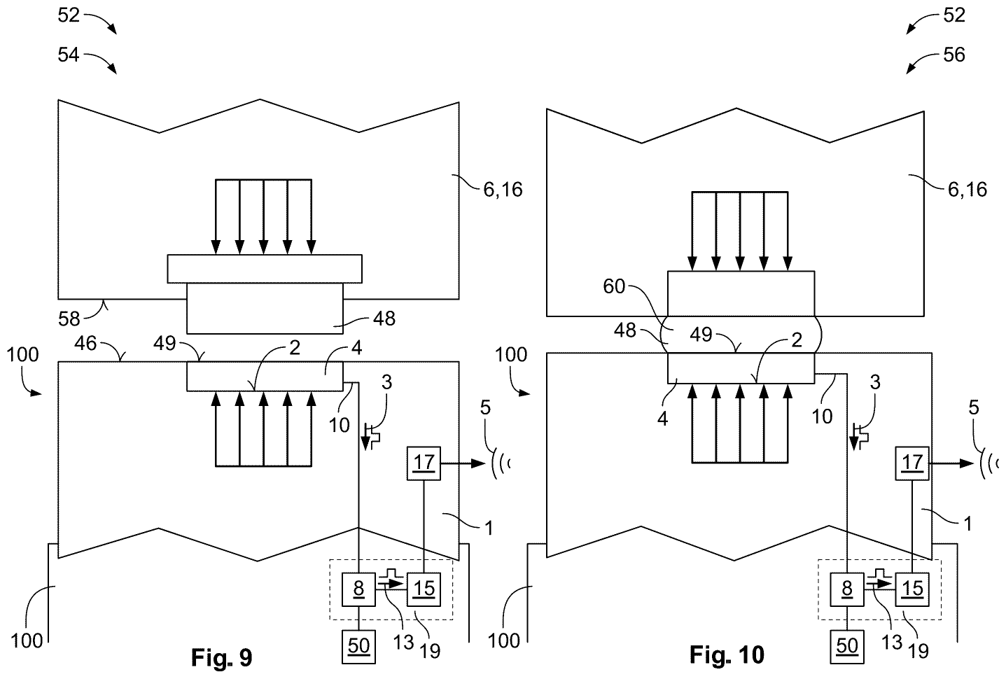

In FIGS. 9 and 10, an exemplary embodiment of a connector arrangement 52 is shown. The connector arrangement 52 comprises an electric connector 1 and a mating connector 6. The electric connector 1 and the mating connector 6 are movable relative to one another between an unmated condition 54 (see FIG. 9) and a fully mated condition 56 (see FIG. 10).

The electric connector 1 comprises a mating face 46 on which the at least one pressure sensor 4 is installed. The mating face 46 preferably comprises a recess such that the at least one pressure sensor 4 may be located in said recess and the sensing area 49 of the at least one pressure sensor 4 is arranged essentially flush with the remainder of the mating face 46. The mating connector 6 may comprise a counter face 58 facing the mating face 46. An elastically compressible intermediate element 48 may project from said counter face 58 such that said intermediate element 48 is compressed at least in the fully mated condition between the counter face 58 and the sensing area 49. Thus, the intermediate element 48 exerts a force on the at least one pressure sensitive surface 2 in its compressed state 60.

In the embodiments shown in FIGS. 9 and 10, the signal 3 is transmitted from the pressure sensor 4 to the detection unit 8, which upon activation sends the signal 15 to the control unit 15. The control unit may at a first predetermined threshold value activate the alarm unit 17, which may be integrated in the electric connector 1 and emits warning signal 5. The warning signal 5 may change upon activation. For example a LED may be provided which lights up when a connection is established and changes its color and/or is switched off when activated.

In the embodiments shown in FIGS. 6 to 10, the fully mated condition 56 is implied by a high pressure. The alarm unit 17 may thus be activated when a pressure drop is registered and an emergency cutoff may be executed if the pressure drops below a predetermined threshold pressure.

A detailed description of the embodiments of the present disclosure has been provided in conjunction with the accompanying drawings. It should be noted that the implementation not shown or described in the accompanying drawings or the text of the specification are all forms known to the person skilled in the art that the present disclosure pertains to and have not been explained in detail. In addition, the above definitions of each of the components are not limited to the various specific structures, shapes, or methods mentioned in the embodiments, which may be easily modified or replaced by the person skilled in the art.

It should also be noted that in specific embodiments of the present disclosure, unless otherwise expressly stated, the numerical parameters in this specification and the attached claims are approximate values that may be changed based on the desired characteristics obtained by the content of the present disclosure. Specifically, all numbers used in the specification and claims to represent the dimensions, range conditions, etc. of the composition should be understood as being modified by the term “approximately” in all cases. In general, the meaning of the expression refers to an inclusion of a specific number of ±10% changes in some embodiments, ±5% changes in some embodiments, ±1% changes in some embodiments, and ±0.5% changes in some embodiments.

The person skilled in the art may understand that the features recorded in various embodiments and/or claims of the present disclosure may be combined or incorporated in multiple ways, even if such combinations or incorporations are not explicitly recorded in the present disclosure. Specifically, without departing from the spirit and teachings of the present disclosure, the features recorded in various embodiments and/or claims of the present disclosure may be combined and/or incorporated in multiple ways. All these combinations and/or incorporations fall within the scope of the present disclosure.

The specific embodiments described above provide further detailed explanations of the purpose, technical scheme, and beneficial effects of the present disclosure. It should be understood that the above explanations are only specific embodiments of the present disclosure and are not intended to limit the present disclosure. Any modifications, equivalent replacements, improvements, etc. made within the spirit and principles of the present disclosure should be comprised in the protection scope of the present disclosure.

1. An electric connector, comprising:
at least one pressure sensitive surface; and
at least one pressure sensor adapted to detect a pressure acting on the at least one pressure sensitive surface and to output a signal in response to the detection of pressure acting on the at least one pressure sensitive surface.

2. The electric connector according to claim 1, further comprising at least one locking feature movable between a release position and a securing position and adapted to secure an element to the electric connector, the at least one pressure sensitive surface is located on the at least one locking feature.

3. The electric connector according to claim 2, wherein the at least one locking feature includes an actuation surface adapted for manual interaction, the at least one pressure sensitive surface is at least partially arranged on the or formed by the actuation surface.

4. The electric connector according to claim 1, further comprising at least one elastically compressible intermediate element, the at least one intermediate element adapted to at least partially press against the at least one pressure sensitive surface at least in a compressed state.

5. The electric connector according to claim 4, wherein the at least one pressure sensor is at least partially embedded in the at least one elastically compressible intermediate element.

6. The electric connector according to claim 5, wherein the at least one elastically compressible intermediate element at least partially rests on the at least one pressure sensor.

7. The electric connector according to claim 4, wherein the at least one elastically compressible intermediate element is a seal or a portion of a seal.

8. The electric connector according to claim 1, further comprising:
a housing; and
an expansion module removably mounted in the housing.

9. The electric connector according to claim 8, wherein the at least one pressure sensor is arranged on the expansion module.

10. The electric connector according to claim 1, further comprising a mating face facing a mating connector in a mating direction, wherein the pressure sensitive surface forms at least part of the mating face.

11. A connector arrangement, comprising:
an electric connector, including:
at least one pressure sensitive surface; and
at least one pressure sensor adapted to detect a pressure acting on the at least one pressure sensitive surface and to output a signal in response to the detection of pressure acting on the at least one pressure sensitive surface; and
a mating connector, the electric connector and mating connector are movable between an unmated condition and a fully mated condition.

12. The connector arrangement according to claim 11, wherein the electric connector and the mating connector exert a pressure on the pressure sensitive surface at least in the fully mated condition.

13. The connector arrangement according to claim 12, wherein the mating connector comprises an elastically compressible intermediate element adapted to directly or indirectly press against the pressure sensitive surface in a compressed state.

14. A system, comprising:
an electric device;
an electric connector adapted to mate with a mating connector and electrically coupled to the electric device, including:
at least one pressure sensitive surface; and
at least one pressure sensor adapted to detect a pressure acting on the at least one pressure sensitive surface and to output a signal in response to the detection of pressure acting on the at least one pressure sensitive surface; and
a detection unit adapted to be activated by a received signal at a predetermined threshold value.

15. The system according to claim 14, further comprising a control unit, the detection unit adapted to send an output signal to the control unit.

16. The system according to claim 15, wherein the control unit is adapted to interrupt a supply of electric power through the electric connector when being activated by the output signal.

17. The system according to claim 16, wherein the control unit is adapted to activate an alarm unit to emit an optical and/or acoustic warning signal at a first predetermined threshold value.

18. The system according to claim 17, wherein the control unit is adapted to interrupt the supply of electric power through the electric connector at a second predetermined threshold value.

19. The system according to claim 18, wherein the first predetermined threshold value is distinct from the second predetermined threshold value.

20. The system according to claim 15, further comprising an evaluation unit adapted to count a number of times the detection unit is activated.
